(19) United States
(12) Patent Application Publication
(10) Pub. No.: US 2015/0341234 A1
(43) Pub. Date: Nov. 26, 2015

(54) METHOD FOR GENERATING GRAPHIC INTERFACE FOR MONITORING NETWORK NODES IN A NETWORK

(71) Applicant: SENAO NETWORKS, INC., New Taipei City (TW)

(72) Inventors: Pin-Chieh YEH, New Taipei City (TW); Chao-Pin WU, New Taipei City (TW); Chun-Tang CHANG, New Taipei City (TW); Pei-Chuan LIU, New Taipei City (TW)

(21) Appl. No.: 14/718,781

(22) Filed: May 21, 2015

(30) Foreign Application Priority Data
May 26, 2014 (TW) 103118264

(51) Int. Cl. H04L 12/26

(52) U.S. Cl. CPC H04L 43/045; H04L 43/0876

(57) ABSTRACT

A method is for generating a graphic interface for monitoring a plurality of network nodes in a network. The network nodes include a plurality of master nodes and a plurality of non-master nodes each being managed by one of the master nodes. In the method, an electronic device executes the steps of: establishing a connection with one of the master nodes that serves as a root node; obtaining a first packet, from each of the network nodes, and obtaining a second packet from each o f the non-master nodes within a management hierarchy of the root node; generating synthesized status data associated with each of the network nodes based on the corresponding one of the packets; and generating the graphic interface containing the synthesized status data.

### CROSS-REFERENCE TO RELATED APPLICATION

This application claims priority of Taiwanese Application No. 103118264, filed on May 26, 2014.

### FIELD

The disclosure relates to a method for generating a graphic interface for monitoring network nodes in a network.

### BACKGROUND

In operating a conventional network management system, a user is required to simultaneously watch and monitor status information of a plurality of network nodes. The status information of each of the network nodes may include a management status, a connection status among the network nodes, a serial number of a particular port used for connecting to other nodes, etc. It is evident that a large amount of information needs to be monitored.

Additionally, the status information for each of the network nodes may be obtained via various networking protocols, and in the conventional network management system, monitoring all the status information requires switching back and forth between a plurality of management page screens, each displaying status information obtained via a specific one of the networking protocols. Moreover, due to the time spent in switching between the management page screens, the data displayed on the screen is) that is not currently “on top” (i.e., not visible cine to other screens blocking the view) and cannot be viewed by the user becomes outdated.

### SUMMARY

Therefore, an object of the disclosure is to provide a method that can alleviate at least one of the drawbacks of the prior art.

According to the disclosure, a method is for generating a graphic interface for monitoring a plurality of network nodes in a network. The network nodes include a plurality of master nodes and a plurality of non-master nodes. Each of the non-master nodes is managed by one of the master nodes. The method is to be implemented by an electronic device and comprising the steps of:

establishing a connection with one of the master nodes that serves as a root node;

obtaining a first packet from each of the network nodes in the network, and obtaining a second packet from each of the non-master nodes that is within a management hierarchy of the root node, each of the first packets and the second packets in dueling at least a media access control (MAC) address associated with a corresponding one of the network nodes;

generating synthesized status data associated with each of the network nodes in the network based on the corresponding one of the first packets, wherein the synthesized status data for each of the non-master nodes that is within the management hierarchy of the root node is generated based further on the corresponding one of the second packets; and

generating the graphic interface containing the synthesized status data.

### BRIEF DESCRIPTION OF THE DRAWINGS

Other features and advantages of the disclosure will become apparent in the following detailed description of the embodiment with reference to the accompanying drawings, of which:

FIG. 1 is a block diagram illustrating an electronic device coupled to a network node device for implementing an embodiment of a method for generating the graphic interface according to the disclosure;

FIG. 2 illustrates a graphic interface generated by the electronic device; and

FIG. 3 is a flow chart illustrating steps of the method.

### DETAILED DESCRIPTION

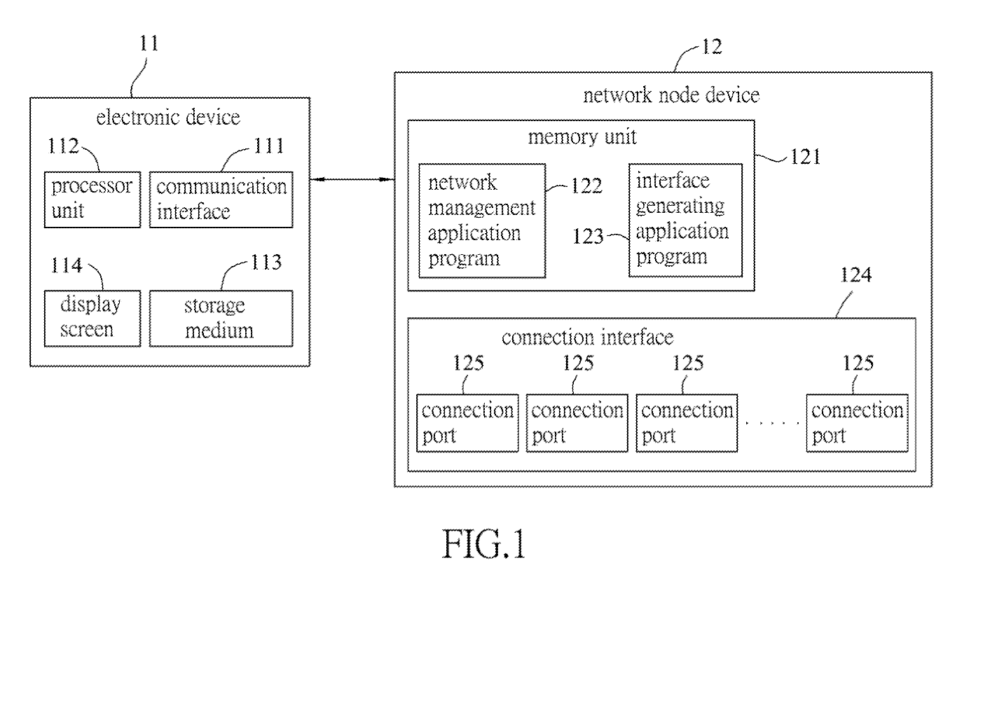

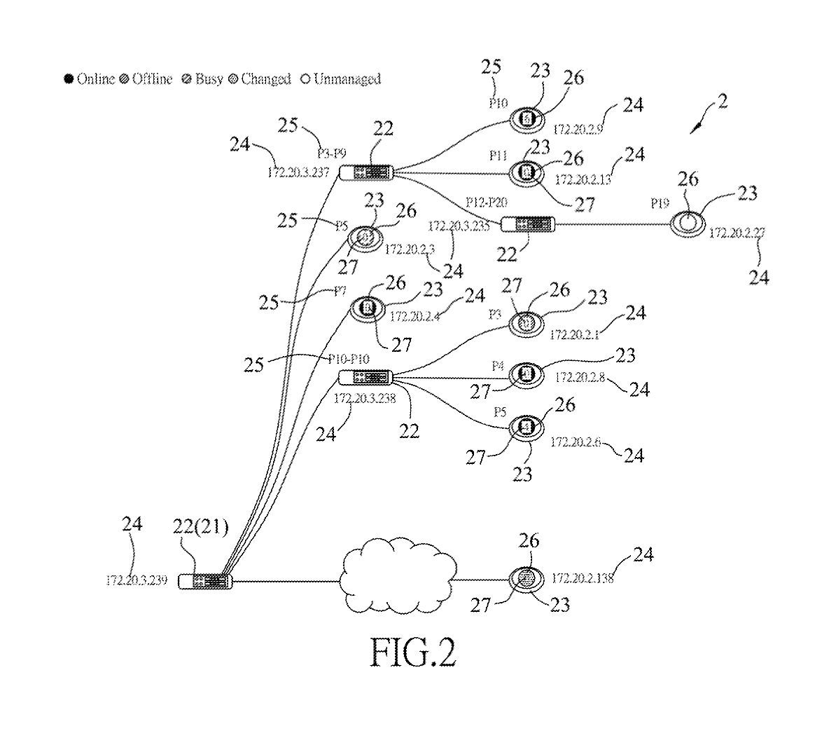

Referring to FIGS. 1 and 2, according to the embodiment of the disclosure, an electronic device 11 is used to implement a method for generating a graphic interface 2 for monitoring a plurality of network nodes in a network. The electronic device 11 may be embodied using, for example, a personal computer (PC), a laptop, a mobile device, a tablet computer, a personal digital assistant (PDA), etc.

The electronic device 11 includes a communication interface ill, a processor unit 112, a storage medium 113 and a display screen 114.

The electronic device 11 is capable of connecting to the network via the communication interface 111. The network nodes of the network include a plurality of master nodes 22 and a plurality of non-master nodes 23, Each of the non-master nodes 23 is managed by one of the master nodes 22.

Each of the master nodes 22 may be embodied using a network node device 12, such as a switch or a router. Each network node device 12 includes a memory unit 121 and a connection interface 124.

The memory unit 121 stores software applications that, when executed by the processor unit 112 of the electronic device 11, causes the processor unit 112 to perform the method. Specifically, in this embodiment, the memory unit 121 stores a network management application program 122 and an interface generating application program 123.

The connection interface 124 includes a plurality of connection ports 125 for physically connecting to other nodes or devices.

Each of the non-master nodes 23 is an access point (AP).

In order to start performing the method, a user of the electronic device 11 is first required to log in one of the master nodes 22 that serves as a root node 21, thereby establishing a connection between the electronic device 11 and the root node 21. In this embodiment the electronic device 11 establishes the connection with the root node 21 using the communication interface 111 and via an Internet Protocol (IP) address.

Afterward, the electronic device 11 executes the network management application program 122. In this embodiment, the electronic device 11 downloads the network management application program 122 from the root node 21. In other embodiments, the network management, application program 122 may be pre-stored in the electronic device 11.

After executing the network management application program 122, the processor unit 112 obtains a first packet from each of the network nodes (i.e., all master nodes 22 and ail non-master nodes 23) in the network, and obtains a second packet from each of the non-master nodes 23 that is within a management hierarchy of the root node 21 (that is, the non-master nodes 23 whose settings can be managed and modified by the root node 21). The first and second packets are then stored in the storage medium 113.

In this embodiment, each of the first packets is obtained via the link layer discovery protocol (LLDP). Content in each of the first packets includes a media access control (MAC) address associated with the corresponding one of the network nodes, and status information associated with the corresponding one of the network nodes.

The states information included in each of the first packets contains a network address 24 (e.g., an IP address) of the corresponding one of the network nodes, and a connection status associated with the corresponding one of the network nodes, i.e., between the corresponding network node and associated one(s) of the network nodes.

For example, the connection states for a master node 22 indicates how each of the connection ports 125 thereof is connected to other network nodes (e.g., other master nodes 22 or the non-master nodes 23). The connection status for a non-master node 23 indicates how the non-master node 23 is connected to the managing master node 22, i.e., one of the master nodes 22 that manages the non-master node 23, (e.g., via which one of the connection ports 125 of the managing master node 22).

On the other hand, each of the second packets is obtained via the control and provisioning of wireless access points (CAPWAP) protocol.

Content in each of the second packets includes a media access control (MAC) address associated with the corresponding one of the non-master nodes 23 that is within the management hierarchy of the root node 21, and status information associated with the corresponding one of the non-master nodes 23 that is within the management hierarchy of the root node 21,

The status in format ion included in each of the second packets contains a network address 24 (e.g., an IP address) of the corresponding one of the non-master nodes 23 that is within the management hierarchy of the root node 21, a management states 26 of the corresponding non-master node 23, and a number of connected devices 27 currently connected to the corresponding non-master node 23. Specifically, the management status 26 indicates that the corresponding non-master node 23 is in one of an online status, an offline status, a busy status, a changed status and an unmanaged status. A network node having the “changed” status indicates that a physical connection of the network node has recently been changed (e.g., the network node being connected via a different connection port), which is a condition worth noting. On the other hand, a network node having the “unmanaged” states indicates that, the network node is not within the management hierarchy of the root node 21, and therefore cannot be managed and modified by the root node 21.

The number of connected devices 27 indicates a number of devices that are currently connected to the corresponding non-master node 23 for obtaining access to the network. For the network nodes having the “unmanaged” status, the number is not known to the root node 21.

After the first and second packets are received; the processor unit 112 of the electronic device 11 executes the interface generating application program 123. In this embodiment, the interface generating application program 123 is created in the form of an executable file (i.e., an .exe file), and is capable of causing the electronic device 11 to generate a graphic page for viewing, and to display the graphic page on the display screen 114.

The interface generating application program 123, when executed, causes the processor unit 112 to generate synthesized status data associated with each of the network nodes in the network based on the corresponding one of the first packets.

It is worth noting that, for each of the non-master nodes 23 that is within the management hierarchy of the root node 21, the synthesized, status data is generated based further on an associated one of the second packets. Specifically, the processor unit 112 is enabled to extract the MAC address contained in each of the second packets, to compare each of the extracted MAC addresses with each of the first packets received, and to combine each of the second packets with a corresponding one of the first packets having an identical MAC address.

As a result, the synthesized status data for each of the master nodes 22 includes the network address 24 and the connection status associated with the master node 22, i.e., between the master node 22 and the associated one(s) of the network nodes. The synthesized status data for each of the non-master nodes 23 includes the network address 24, the connection status associated with the non-master node 23, i.e., between the non-master node 23 and the managing master node 22, the management status 26 of the non-master node 23, and the number of connected devices 27 currently connected to the non-master node 23.

With the synthesized status data available, the processor unit 112 generates the graphic interface 2 (i.e., the graphic page) that contains the synthesized status data (as best seen in FIG. 2), and controls the display screen 114 to display the graphic interface 2.

The graphic interface 2 includes a set of first icons each representing one of the master nodes 22, and a set of second icons each representing one of the non-master nodes 23. The synthesized status data of each network node is illustrated over or near the corresponding status icon. For example, for a non-master node 23, the connection status associated therewith, i.e., between the non-master node 23 and the associated one of the master nodes 22, is represented by a line interconnecting the second icon representing the non-waster node 23 and the first icon representing the associated master node 22, and a serial number 25 (e.g., P5) beside the second icon to represent one of the connection ports 125 of the associated master node 22 to which the non-master node 23 is connected. As for a master node 22 that is not the root node 21, the connection status associated therewith, i.e., between the master node 22 and the associated one(s) of the network nodes (which may be another master node 22 and one or more of the non-master nodes 23), besides having an interconnecting line interconnecting the master node 22 and each associated network node, a pair of serial numbers 25 (e.g., P3-P9) is shown to represent the connection, ports 125 of the connected master nodes 22 with a first one of the serial numbers 25 (i.e., P3) representing one of the connection ports 125 of said another master node 22 to which one of the connection ports 125 of said mater node 22 that is represented by a second one of the serial numbers (i.e., P9) is connected. The management status 26 of a non-master node 23 may foe displayed in the form of a graphic pattern, e.g., colored pattern, inside the corresponding second icon. The number of connected devices 27 of a non-master node 23 may be displayed in the form of a numeral superimposed on the corresponding second icon. It is noted that for a non-master node 23 that is not managed by the root node 21 (unmanaged), the number of connected devices 27 is omitted, since the number is not known to the root node 21. For a network node that is not connected to any devices or whose connected devices are offline, the number of connected devices 27 is shown to be zero.

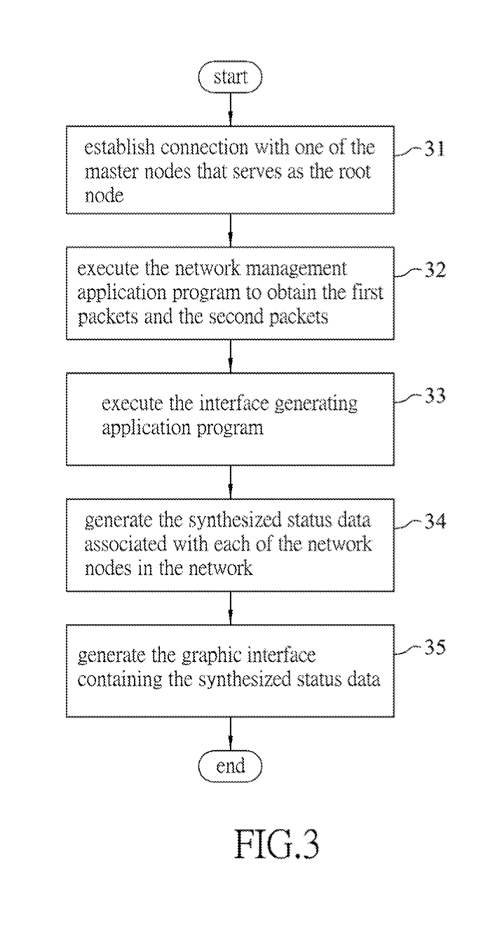

Referring to FIG. 3, the method for generating a graphic interface 2 according to the embodiment will now be described in the following paragraphs.

In step 31, a user using the electronic device 11 logs in one of the master nodes 22 that serves as the root node 21, thereby establishing a connection between the electronic device 11 and the root node 21.

In step 32, the electronic device 11 executes the network, management application program 122, which may be pre-stored or downloaded from the root node 21, in order to obtain the first packets and the second packets.

In step 33, the electronic device 11 executes the interface generating application program 123, which may be pre-stored or downloaded from the root node 21.

In step 34, the electronic device 11 generates the synthesized states data associated with each of the network nodes in the network.

In step 35, the electronic device 11 generates the graphic interface 2 containing the synthesized status data.

To sum up, the embodiment of the disclosure provides a method to generate the graphic interface 2 that is capable of enabling data obtained from different networking protocols to be converted into the synthesized status data, and displaying the synthesized status data on one single screen. This may eliminate the need to switch back and forth between a plurality of management page screens. Moreover, the synthesized status data is presented in a more straight forward way in order to make the graphic interface 2 easier to comprehend (for example, the management status 26 is displayed using a graphic pattern), In addition, the displayed information may be refreshed altogether.

While the disclosure has been described in connection with what is considered the exemplary embodiment, it is understood that this disclosure is not limited to the disclosed embodiment but is intended to cover various arrangements included within the spirit and scope of the broadest interpretation so as to encompass ail such modifications and equivalent arrangements.

What is claimed is:

1. A method for generating a graphic interface for monitoring a plurality of network nodes in a network, the network nodes including a plurality of master nodes and a plurality of non-master nodes, each of the non-master nodes being managed by one of the master nodes, the method to be implemented by an electronic device and comprising the steps of:
a) establishing a connection with one of the master nodes that serves as a root node;
b) obtaining a first packet from each of the network nodes in the network, and obtaining a second packet from each of the non-master nodes that is within a management hierarchy of the root node, each of the first packets and the second packets including at least a media access control (MAC) address associated with a corresponding one of the network nodes;
c) generating synthesized status data associated with each of the network nodes in the network based on the corresponding one of the first packets, wherein the synthesized status data for each of the non-master nodes that is within the management hierarchy of the root node is generated based further on the corresponding one of the second, packets; and
d) generating the graphic interface containing the synthesized status data generated in step c).

2. The method of claim 1, further comprising, after step a), the step of downloading a network management application program from the root node,
wherein, in step b), the electronic device executes the network management application program to obtain the first packets and the second packets.

3. The method of claim 1, further comprising, after step a), the step of downloading an interface generating application program from the root node,
wherein, in step d), the electronic device executes the interface generating application program to generate the graphic interface.

4. The method of claim 1, wherein, in step b), each of the first packets is obtained via the link layer discovery protocol (LLDP), and further includes status information associated with the corresponding one of the network nodes.

5. The method of claim 4, wherein the status information includes a network address of the corresponding one of the network nodes and a connection status between the corresponding one of the network nodes and an associated one of the network nodes.

6. The method of claim 1, wherein, in step b), each of the second packets is obtained via the control and provisioning of wireless access points (CAPWAP) protocol, and further includes status information of the corresponding one of the non-master nodes that is within the management hierarchy of the root node.

7. The method of claim 6, wherein, for each of the non-master nodes that is within the management hierarchy of the root node, the status information includes a management status of the non-master node, and a number of devices currently connected to the non-master node.

8. The method of claim 7, wherein the management status indicates that the non-master node is in one of an online status, an offline status, a busy status, a changed status and an unmanaged status.

9. The method of claim 1, wherein, in step c):
the synthesized status data for each of the master nodes includes a network address and a connection status between the master node and associated one(s) of the network, nodes; and the synthesized status data for each of the non-master nodes includes a network address, a connection states between the non-master node and the one of the master nodes that manages the non-master node, a management status of the non-master node, and a number of devices currently connected to the non-master node.

10. The method of claim 1, wherein the graphic interface includes a set of first icons each representing one of the master nodes, and a set of second icons each representing one of the non-master nodes.

11. The method of claim 10, wherein:
the synthesized status data for each of the master nodes includes a network address and a connection status between the master node and associated one(s) of the network nodes; and
the synthesized status data for each of the non-master nodes includes a network address, a connection status between the non-master node and the one of the master nodes that manages the non-master node, a management states of the non-master node, and a number of devices currently connected to the non-master node.

12. The method of claim 11, wherein the connection status is incorporated into the graphic interface in the form of at least one of an interconnecting line, text and a graphic pattern.

13. The method of claim 1, wherein each of the master nodes is one of a switch and a router.

14. The method of claim 1, wherein each of the non -master nodes is an access point.

15. The method of claim 1, further comprising, after step d), the step of displaying the graphic interface on a display screen of the electronic device.
